(19) United States
(12) Patent Application Publication
(10) Pub. No.: US 2012/0181894 A1
(43) Pub. Date: Jul. 19, 2012

(54) ROTOR FOR ROTARY ELECTRIC MACHINE

(75) Inventors: Takashi Asaga, Toyota-shi (JP); Toshiya Sugiyama, Okazaki-shi (JP)

(73) Assignee: AISIN SEIKI KABUSHIKI KAISHA, Kariya-shi (JP)

(21) Appl. No.: 13/343,783

(22) Filed: Jan. 5, 2012

(30) Foreign Application Priority Data
Jan. 14, 2011 (JP) 2011-005492

(51) Int. Cl. H02K 1/28

(52) U.S. Cl. 310/216.114

(57) ABSTRACT

A rotor for a rotary electric machine, the rotor being arranged to face a stator and being roratably attached to a housing, the rotor includes a core body formed by a plurality of core sheets laminated in a direction of a rotational axis of the rotor, first and second end plates arranged at both end surfaces of the core body in a direction where the core sheets are laminated, and a fixing member fixing the first and second end plates to the core body to hold the core body by the first and second end plates, wherein at least one of the first and second end plates is formed by a plurality of composition members overlapping in a thickness direction of the first end plate and the second end plate.

### CROSS REFERENCE TO RELATED APPLICATIONS

This application is based on and claims priority under 35 U.S.C. §119 to Japanese Patent Application 2011-005492, filed on Jan. 14, 2011, the entire content of which is incorporated herein by reference.

### TECHNICAL FIELD

This disclosure generally relates to a rotor for a rotary electric machine.

### BACKGROUND DISCUSSION

A known rotor for an electric motor is disclosed in JP11-98733 (hereinafter referred to as Reference 1), for example. The rotor disclosed in Reference 1 includes a rotor core that is formed by a lamination of plural magnetic steel sheets and that is sandwiched by a pair of end plates in a direction where the magnetic steel sheets are laminated. A motor shaft including a protruding portion at one axial end penetrates through the rotor core and the end plates. Then, a retaining nut is tightened to the other axial end of the motor shaft to thereby hold the rotor core relative to the motor shaft by means of the pair of end plates.

According to the rotor for the electric motor disclosed in Reference 1, annular stepped portions are formed at respective end portions of the end plates. In addition, a coil wound on the stator core is bent in a radially outward direction. Therefore, an air gap formed between an outer peripheral edge of each of the end plates and an inner peripheral surface of the coil increases, which leads to a reduction of a flux linkage relative to the end plates. An occurrence of over-current at the end plates is restrained to thereby improve an operation efficiency of the electric motor.

However, according to the electric motor disclosed in Reference 1, the coil is bent in the radially outward direction. Thus, a housing accommodating the stator is enlarged. In addition, because the coil is bent, a coating of the coil may be damaged, which results in a difficulty in manufacturing the stator.

On the other hand, according to the electric motor disclosed in Reference 1, both end surfaces of the rotor core are held by the end plates so that the rotor core is strongly held against a centrifugal force of the rotor in a state where the centrifugal force is generated at the rotor core in association with a rotation of the rotor.

In order to strongly hold the rotor core against the centrifugal force of the rotor, a rigidity of each of the end plates is required to increase. Thus, it is considered to increase a thickness of the end plate.

However, in a case where the thickness of each of the end plates increases, a pressing load to manufacture the end plate should increase, which leads to a decrease in accuracy of forming dimensions and an enlargement of a pressing machine for manufacturing the end plate. Further, in this case, a durability of a press die to form the end plate decreases, thereby increasing a manufacturing cost caused by an increased frequency of replacing the press die.

A need thus exists for a rotor for a rotary electric machine which is not susceptible to the drawback mentioned above.

### SUMMARY

According to an aspect of this disclosure, a rotor for a rotary electric machine, the rotor being arranged to face a stator and being roratably attached to a housing, the rotor includes a core body formed by a plurality of core sheets laminated in a direction of a rotational axis of the rotor, first and second end plates arranged at both end surfaces of the core body in a direction where the core sheets are laminated, and a fixing member fixing the first and second end plates to the core body to hold the core body by the first and second end plates, wherein at least one of the first and second end plates is formed by a plurality of composition members overlapping in a thickness direction of the first end plate and the second end plate.

According to another aspect of this disclosure, a rotor for a rotary electric machine, the rotor being arranged to face a stator and roratably attached to a housing, the rotor includes a core body formed by a plurality of core sheets laminated in a direction of a rotational axis of the rotor, first and second end plates arranged at both end surfaces of the core body in a direction where the core sheets are laminated, and a fixing member fixing the first and second end plates to the core body to hold the core body by the first and second end plates, wherein one of the end plates is formed by a plurality of composition members overlapping in a thickness direction, each of the plurality of composition members including an annular shape and a plurality of through-bores arranged at predetermined intervals in a circumferential direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view of an electric motor in a state to be mounted to a vehicle according to a first embodiment disclosed here;

FIG. 2 is a plan view of a rotor provided at the electric motor in FIG. 1 in a state where the rotor is viewed in a left side in FIG. 1;

FIG. 3 is a partially enlarged view of the rotor in FIG. 1;

FIG. 4 is a plan view of a first end plate of the rotor in FIG. 1 in a state where the first end plate is viewed in a left side in FIG. 1;

FIG. 5 is a plan view of a fourth end plate of the rotor in FIG. 1 in a state where the fourth end plate is viewed in a left side in FIG. 1; and

FIG. 6 is a partially enlarged cross-sectional view of a rotor according to a second embodiment disclosed here.

### DETAILED DESCRIPTION

### First Embodiment

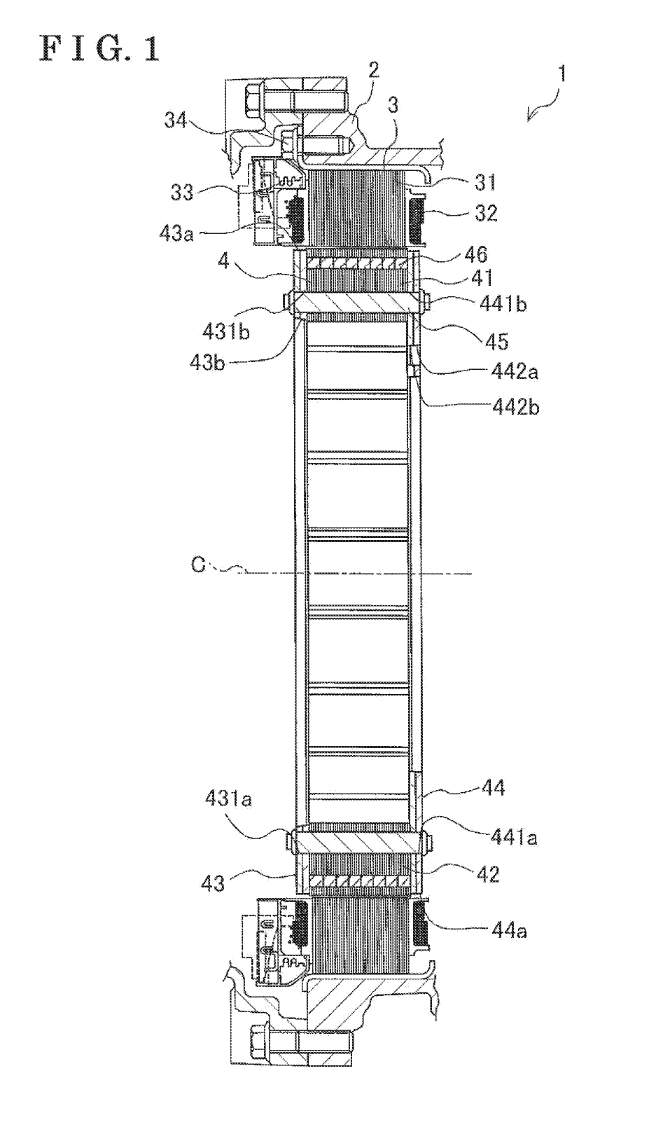

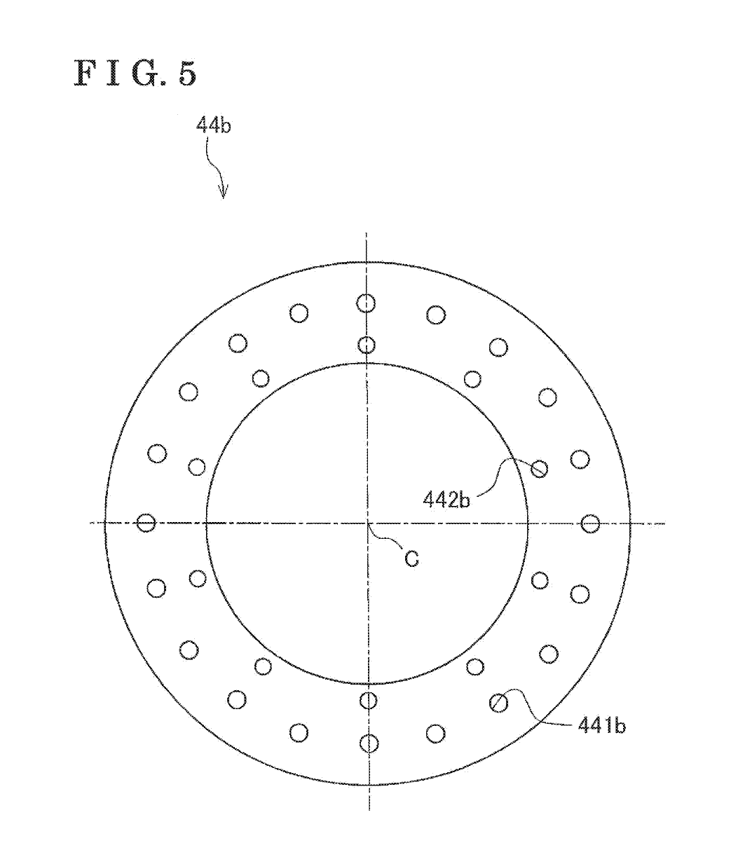

A rotor 4 of an electric motor 1 according to a first embodiment will be explained with reference to FIGS. 1 to 5.

The electric motor 1 serving as a rotary electric machine according to the first embodiment is a synchronous motor for driving wheels of a hybrid vehicle. The electric motor 1 is arranged between a clutch device connected to an engine and a transmission. The electric motor 1 of the present embodiment, however, may be applicable to any types of electric motors such as a motor provided at a household electric appliance and a motor driving industrial machinery.

In an explanation below, a rotational axis direction or an axial direction corresponds to a direction along a rotational axis C of the electric motor 1 (the rotor 4), i.e., a left and right direction in FIG. 1 unless otherwise mentioned. In addition, a left side in FIG. 1 corresponds to a front side of the vehicle while a right side in FIG. 1 corresponds to a rear side of the vehicle.

As illustrated in FIG. 1, a motor housing 2 serving as a housing is integrally formed by an aluminum alloy, for example. The motor housing 2 accommodates a stator 3 and the rotor 4 of the electric motor 1. The engine is attached to the front side of the motor housing 2 while the transmission is provided at the rear side of the motor housing 2.

The stator 3 is attached to an inner peripheral portion of the motor housing 2 by means of a screw 34. The stator 3 includes plural cores 31 on which a coil 32 is wound so as to generate a rotating magnetic field. The coil 32 is connected to an external inverter via a bus ring 33.

The rotor 4 of the electric motor 1 is arranged at a radially inner side of the stator 3. The rotor 4 is provided to face the stator 3 while having a predetermined gap therewith. The rotor 4 is rotatable relative to the motor housing 2. The rotor 4 includes a core body 41 formed by a lamination of plural steel sheets 42 serving as core sheets in the direction of the rotational axis C.

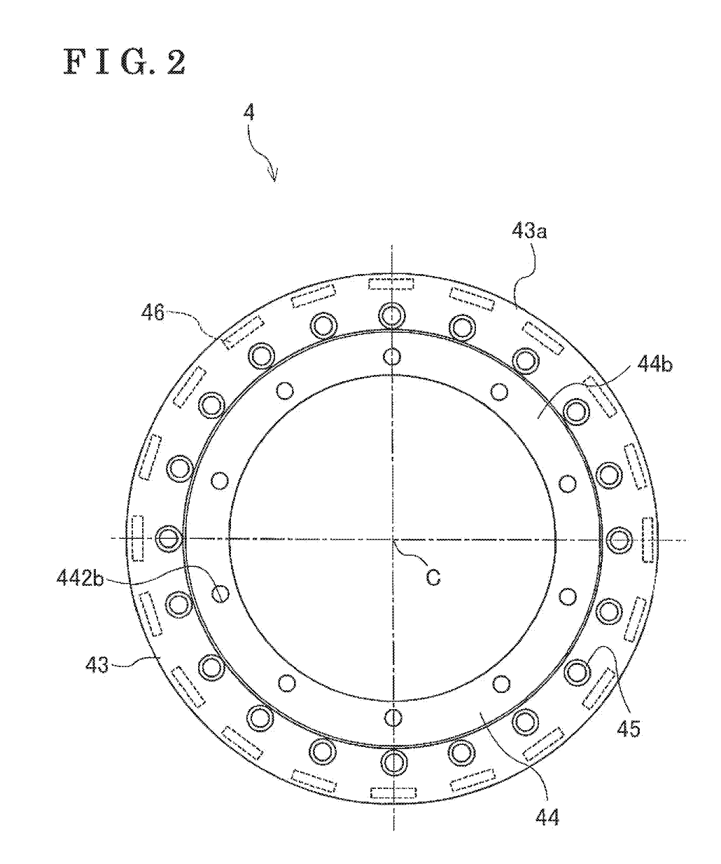

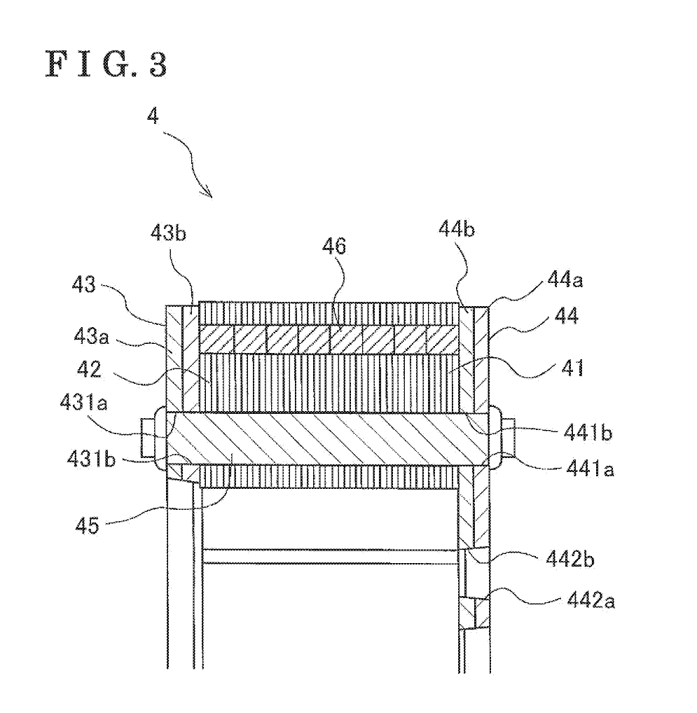

As illustrated in FIGS. 1 and 3, a first end plate 43 and a second end plate 44 each having a plate shape and serving as first and second end plates sandwich both end surfaces of the core body 41. In the aforementioned state, plural tightening pins 45 each serving as a fixing member penetrate through the core body 41 in a laminating direction thereof together with the first and second end plates 43 and 44. Both end portions of each of the tightening pins 45 are riveted so as to engage with the first and second end plates 43 and 44 respectively. As a result, the first and second end plates 43 and 44 are restrained from being separated from each other while holding the core body 41. In addition, as illustrated in FIG. 2, a field pole magnet 46 having twenty magnetic poles is provided at a circumferential edge of the rotor 4.

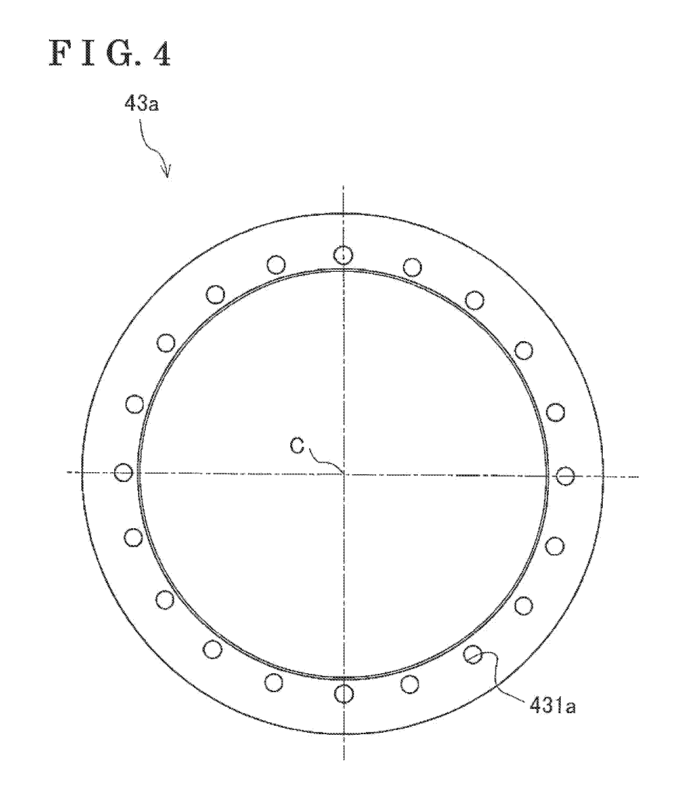

As illustrated in FIG. 3, the first end plate 43 includes a first composition sheet member 43a serving as a first composition member and a second composition sheet member 43b serving as a second composition member. The first composition sheet member 43a, substantially formed into a ring shape, includes twenty of first bores 431a each serving as a through-bore into which the tightening pins 45 are inserted respectively. The first holes 431a are arranged at an outer peripheral side of the first composition sheet member 43a at even intervals (i.e., at predetermined intervals) in a circumferential direction as illustrated in FIG. 4.

The second composition sheet member 43a, substantially formed into the ring shape, includes twenty of second bores 431b each serving as the through-bore into which the tightening pins 45 are inserted respectively. The second bores 431b of the second composition sheet member 43a are positioned to face the first bores 431a of the first composition sheet member 43a respectively. The second bores 431b are arranged at an outer peripheral side of the second composition sheet member 43a (see FIG. 3) at the even intervals in the circumferential direction in the same way as the first bores 431a of the first composition sheet member 43a. Outer peripheral surfaces of the first composition sheet member 43a and the second composition sheet member 43a are formed to substantially have the same diameter while inner peripheral surfaces of the first composition sheet member 43a and the second composition sheet member 43a are formed to substantially have the same diameter.

Plate thicknesses of the first and second composition sheet members 43a and 43b may be the same or different. At least a total thickness of the first and second composition sheet members 43a and 43b is desirably substantially equal to a thickness of a known end plate formed by a single plate member.

As illustrated in FIG. 3, the first and second composition sheet members 43a and 43b are arranged at a front end surface of the core body 41 while overlapping each other in a thickness direction thereof. The second composition sheet member 43a is arranged at an inner side in the rotational axis direction so as to be in contact with the core body 41. The first composition sheet member 43a is arranged at an outer side in the rotational axis direction. The first composition sheet member 43a is not in contact with the core body 41 because the second composition sheet member 43a is disposed between the first composition sheet member 43a and the core body 41.

In the same way, the second end plate 44 includes a third composition sheet member 44a serving as a third composition member and a fourth composition sheet member 44b serving as a fourth composition member. The third composition sheet member 44a, substantially formed into the ring shape, includes twenty of third bores 441a each serving as the through-bore into which the tightening pins 45 are inserted respectively. The third bores 441b of the third composition sheet member 44a are positioned to face the first bores 431a of the first composition sheet member 43a respectively. The third bores 441b are arranged at an outer peripheral side of the third composition sheet member 44a at the even intervals in the circumferential direction.

The third composition sheet member 44a extends in a radially inner direction from a portion where the third bores 441b are formed. An inner peripheral surface of the third composition sheet member 44a has a smaller diameter than the diameter of the inner peripheral surface of each of the first and second composition sheet members 43a and 43b. The third composition sheet member 44a includes plural bolt holes 442a each serving as a through-hole between the third bores 441b and the inner peripheral surface of the third composition sheet member 44a. Connection bolts are inserted into the bolt holes 442a so that an inner peripheral portion of the second end plate 44 is connected to a drum member. The second end plate 44 is rotatably attached to the motor housing 2 by means of the drum member.

The fourth composition sheet member 44b, substantially formed into the ring shape, includes twenty of fourth bores 441b each serving as the through-bore into which the tightening pins 45 are inserted respectively. The fourth bores 441b of the fourth composition sheet member 44b are positioned to face the third bores 441b of the third composition sheet member 44a respectively. The fourth bores 441b are arranged at an outer peripheral side of the fourth composition sheet member 44b at the even intervals in the circumferential direction. Outer peripheral surfaces of the third composition sheet member 44a and the fourth composition sheet member 44b are formed to substantially have the same diameter.

The fourth composition sheet member 44b also extends in the radially inner direction from a portion where the fourth bores 441b are formed. An inner peripheral surface of the fourth composition sheet member 44b has a smaller diameter than the diameter of the inner peripheral surface of each of the first and second composition sheet members 43a and 43b. The fourth composition sheet member 44b includes plural bolt holes 442b each serving as the through-hole into which the connection bolts are inserted. The bolt holes 442b are arranged between the fourth bores 441b and the inner peripheral surface of the fourth composition sheet member 44b.

Plate thicknesses of the third composition sheet member 44a and the fourth composition sheet member 44b may be the same or different. At least a total thickness of the third and fourth composition sheet members 44a and 44b is desirably substantially equal to a thickness of the known end plate formed by the single plate member.

As illustrated in FIG. 3, the third composition sheet member 44a and the fourth composition sheet member 44b are arranged at a rear end surface of the cover body 41 while overlapping each other in the thickness direction thereof. The fourth composition sheet member 44b is arranged at the inner side in the rotational axis direction so as to be in contact with the core body 41. On the other hand, the third composition sheet member 44a is arranged at the outer side in the rotational axis direction. The third composition sheet member 44a is not in contact with the core body 41 because the fourth composition sheet member 44b is disposed between the third composition sheet member 44a and the core body 41.

The first composition sheet member 43a and the second composition sheet member 43a overlapping each other may be formed by different materials. In addition, the third composition sheet member 44a and the fourth composition sheet member 44b overlapping each other may be formed by different materials.

As explained above, the second composition sheet member 43a and the fourth composition sheet member 44b that are provided to face the core body 41 and to be in contact with the core body 41 are each formed by either austenitic stainless steel, copper, brass, aluminum, or aluminum alloy each serving as a nonmagnetic (feeble magnetic) metallic material. At this time, the second composition sheet member 43a and the fourth composition sheet member 44b serve as a first portion while facing the core body 41.

On the other hand, the first composition sheet member 43a and the third composition sheet member 44a that are arranged away from the core body 41 and not to be in contact with the core body 41 may be also formed by either austenitic stainless steel, copper, brass, aluminum, or aluminum alloy each serving as the nonmagnetic (feeble magnetic) metallic material, or formed by rolled steel (steel) serving as a magnetic material. At this time, the first composition sheet member 43a and the third composition sheet member 44a serve as a second portion while being arranged to be most away from the core body 41.

In the electric motor 1 having the aforementioned configuration, a three-phase alternating current, for example, is supplied from a vehicle battery to the coil 32 via the inverter. Then, the rotating magnetic field is generated at the stator 3 so that the rotor 4 rotates relative to the stator 3 by means of a suction force or a repulsive force caused by the rotating magnetic field.

According to the aforementioned first embodiment, the first end plate 43 is obtained by the first and second composition sheet members 43a and 43b overlapping each other in the thickness direction while the second end plate 44 is obtained by the third and fourth composition sheet members 44a and 44b overlapping each other in the thickness direction. Therefore, the thickness of each of the first to fourth composition sheet members 43a, 43b, 44a, and 44b is formed to be smaller than the thickness of the known end plate formed by the single plate member. As a result, an over-current generated at the first to fourth composition sheet members 43a, 43b, 44a, and 44b may decrease while the electric motor 1 is inhibited from being enlarged or the production of the electric motor 1 is inhibited from being difficult, which leads to an improvement of an operation efficiency of the electric motor 1.

In addition, in a case where the total thickness of the first and second composition sheet members 43a and 43b laminated each other and the total thickness of the third and fourth composition sheet members 44a and 44b laminated each other are each equalized to the thickness of the known end plate formed by the single plate member, a pressing load of the individual first, second, third, and fourth composition sheet members 43a, 43b, 44a, and 44b constituting the first and second end plates 43 and 44 is reduced without a decrease in rigidity of the first and second end plates 43 and 44. Thus, a decrease in accuracy of forming dimensions of the first and second end plates 43 and 44 is restrained and an enlargement of a pressing machine for manufacturing the first and second end plates 43 and 44 is avoidable. Further, a durability of a press die for the first to fourth composition sheet members 43a, 43b, 44a, and 44b increases, which results in a reduction of a manufacturing cost of the press die.

Furthermore, compared to the known end plate formed by the single plate member, the plate thickness of each of the first to fourth composition sheet members 43a, 43b, 44a, and 44b is smaller. Thus, each of the first to fourth composition sheet members 43a, 43b, 44a, and 44b is restrained from being magnetized because of a distortion upon a press-molding, thereby decreasing a flux leakage to the first end plate 43 and the second end plate 44.

Furthermore, in a case where the materials of the first and second composition sheet members 43a and 43b are different from each other and/or the materials of the third and fourth end plates 44a and 44b are different from each other, the second composition sheet member 43a and/or the fourth composition sheet member 44b provided to face the core body 41 is formed by the nonmagnetic metallic material and the first composition sheet member 43a and/or the third composition sheet member 44a provided to be away from the core body 41 is formed, without a consideration of the magnetic material or the nonmagnetic material, by a low-cost metallic material such as rolled steel. The reduction of the flux leakage to the first end plate 43 and the second end plate 44, and the reduction of the manufacturing cost of the first end plate 43 and the second end plate 44 are both achieved.

Furthermore, in a case where the second composition sheet member 43a and/or the fourth composition sheet member 44b provided to face the core body 41 is formed by aluminum or aluminum alloy, the flux leakage to the first end plate 43 and the second end plate 44 is reduced to thereby improve the performance of the electric motor 1.

Furthermore, each of the first, second, third, and fourth composition sheet members 43a, 43b, 44a, and 44b formed by aluminum or aluminum alloy is inhibited from being magnetized because of the distortion that may occur at the time of press-molding. Thus, the flux leakage to the first and second end plates 43 and 44 is further reduced.

### Second Embodiment

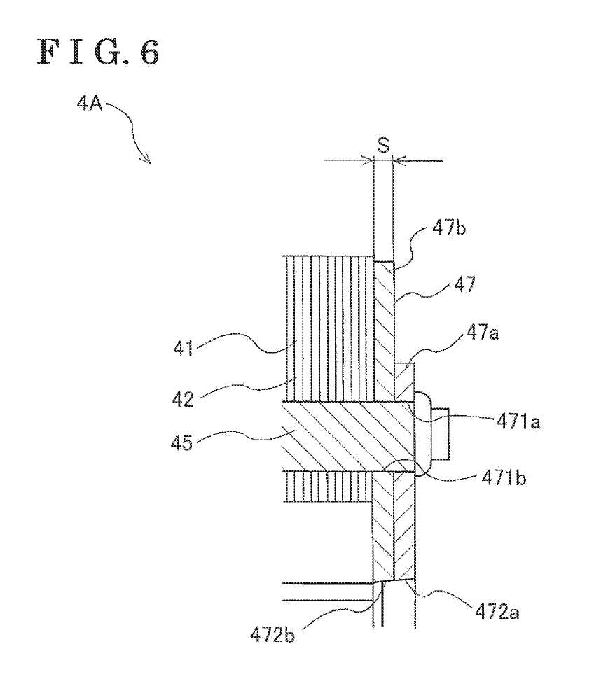

A third end plate 47 serving as the second end plate according to a second embodiment will be explained with reference to FIG. 6. The same components or members of the second embodiment as those of the first embodiment bear the same reference numerals as the first embodiment and an explanation will be omitted. The third end plate 47 according to the second embodiment will be explained with reference to FIG. 6. As illustrated in FIG. 6, the third end plate 47 of a rotor 4A includes a fifth composition sheet member 47a serving as the third composition member and a sixth composition sheet member 47b serving as the fourth composition member. The fifth composition sheet member 47a, substantially formed into the ring shape, includes twenty of fifth bores 471a each serving as the through-bore into which the tightening pins 45 are inserted respectively. The fifth bores 471b are arranged at an outer peripheral side of the fifth composition sheet member 47a at the even intervals in the circumferential direction as in the same way as the third composition sheet member 44a of the first embodiment.

The fifth composition sheet member 47a radially inwardly extends from a portion where the fifth bores 471b are formed. An inner peripheral surface of the fifth composition sheet member 47a has a diameter smaller than the diameter of the inner peripheral surface of each of the first and second composition sheet members 43a and 43b. Plural bolt holes 472a each serving as the through-hole are arranged between the inner peripheral surface of the fifth composition sheet member 47a and the fifth bores 471b.

The sixth composition sheet member 47b, substantially formed into the ring shape and having the similar configuration of the fourth composition sheet member 44b of the first embodiment, includes twenty of sixth bores 471b each serving as the through-bore into which the tightening pins 45 are inserted respectively. The sixth composition sheet member 47b radially inwardly extends from a portion where the sixth bores 471b are formed. An inner peripheral surface of the sixth composition sheet member 47b has a diameter being substantially equal to the diameter of the inner peripheral surface of the fifth composition sheet member 47a. Plural bolt holes 472b each serving as the through-hole are arranged between the inner peripheral surface of the sixth composition sheet member 47b and the sixth bores 471b.

As illustrated in FIG. 6, an outer peripheral surface of the fifth composition sheet member 47a has a smaller diameter than a diameter of an outer peripheral surface of the sixth composition sheet member 47b (i.e., an outer diameter of the fifth composition sheet member 47a is smaller than an outer diameter of the sixth composition sheet member 47b). Therefore, an annular cross section of an outer peripheral end of the third end plate 47 (which is indicated by S in FIG. 6) is reduced, which leads to a decrease of a magnetic flux entering the third end plate 47 among the magnetic flux generated by the coil 32 of the stator 3. As a result, the flux leakage to the outside of the core body 41 is restrained.

According to the second embodiment, the outer diameter of the fifth composition sheet member 47a arranged to be separated from the core body 41 is smaller than the outer diameter of the sixth composition sheet member 47b arranged to face the core body 41. Thus, the flux leakage from the core body 41 is further reduced, thereby improving the operation efficiency of the electric motor 1.

In addition, because the outer diameter of the sixth composition sheet member 47b arranged to face the core body 41 is not reduced, a force to hold the core body 41 is inhibited from decreasing.

The first and second embodiments are not limited to have the aforementioned configurations and may be appropriately modified as below.

Only one of the first end plate 43 and the second end plate 44 may be formed by the first and second composition sheet members 43a and 43b or by the third and fourth composition sheet members 44a and 44b.

In addition, the first end plate 43 or the second end plate 44 may be formed by three or more of the end plates.

Further, instead of the tightening pins 45, bolts may penetrate through the first end plate 43 and/or the second end plate 44 so that the bolts are tightened by nuts, thereby holding the core body 41 by the first and second end plates 43 and 44.

The electric motor 1 according to the first and second embodiments is applicable as a synchronous motor, an induction motor, a continuous current motor, or any other rotary electric machines. In addition, the electric motor 1 of the first and second embodiments may be used only as the electric motor or as the electric generator.

According to the aforementioned first and second embodiments, the rotor 4, 4A for the electric motor 1, the rotor 4, 4A being arranged to face the stator 3 and being roratably attached to the housing 2, the rotor 4, 4A includes the core body 41 formed by the plural steel sheets 42 laminated in the direction of the rotational axis C of the rotor 4, 4A, the first and second end plates 43 and 44 (the third end plate 47) arranged at both end surfaces of the core body 41 in the direction where the steel sheets 42 are laminated, and the tightening pins 45 fixing the first and second end plates 43 and 44 (the third end plate 47) to the core body 41 to hold the core body 41 by the first and second end plates 43 and 44 (the third end plate 47). At least one of the first and second end plates 43 and 44 (the third end plate 47) is formed by the first and second composition sheet members 43a and 43b or the third and fourth composition sheet members 44a and 44b (the fifth and sixth composition sheet members 47a and 47b) overlapping in the thickness direction of the first end plate 43 and the second end plate 44 (the third end plate 47).

According to the aforementioned first and second embodiments, at least one of the first and second end plates 43 and 44 (the third end plate 47) is formed by the first and second composition sheet members 43a and 43b or by the third and fourth composition sheet members 44a and 44b (the fifth and sixth composition sheet members 47a and 47b) laminated in the thickness direction. Thus, the thickness of each of the first to fourth composition sheet members 43a, 43b, 44a, and 44b (the fifth and sixth composition sheet members 47a and 47b) is smaller than the thickness of the known plate formed by the single plate member. Thus, the over-current generated at the first to fourth composition sheet members 43a, 43b, 44a, and 44b (the fifth and sixth composition sheet members 47a and 47b) may decrease while the electric motor 1 is inhibited from being enlarged or the production of the electric motor 1 is inhibited from being difficult, which leads to the improvement of the operation efficiency of the electric motor 1. In addition, in a case where the total thickness of the laminated first and second composition sheet members 43a and 43b or the laminated third and fourth composition sheet members 44a and 44b (the laminated fifth and sixth composition sheet members 47a and 47b) is equalized to the thickness of the known plate formed by the single plate member, the pressing load for each of the first to fourth composition sheet members 43a, 43b, 44a, and 44b (the fifth and sixth composition sheet members 47a and 47b) constituting the first and second end plates 43 and 44 (the third end plate 47) is reduced, without the decrease in rigidity of the first and second end plates 43 and 44 (the third end plate 47). Thus, the decrease in accuracy of forming dimensions of the first and second end plates 43 and 44 (the third end plate 47) is restrained and the enlargement of the pressing machine for manufacturing the first and second end plates 43 and 44 (the third end plate 47) is avoidable. Further, the durability of the press die for the first to fourth composition sheet members 43a, 43b, 44a, and 44b (the fifth and sixth composition sheet members 47a and 47b) increases, which results in the reduction of the manufacturing cost of the press die.

In addition, according to the aforementioned first and second embodiments, the first to fourth composition sheet members 43a, 43b, 44a, and 44b (the fifth and sixth composition sheet members 47a and 47b) are formed by different materials from one another.

Accordingly, the second composition sheet member 43b and the fourth composition sheet member 44b (the sixth composition sheet member 47b) provided to face the core body 41 is formed by the nonmagnetic metallic material and the first composition sheet member 43a and the third composition sheet member 44a (the fifth composition sheet member 47a) provided to be away from the core body 41 is formed, without the consideration of the magnetic material or the nonmagnetic material, by the low cost metallic material. A reduction of the flux leakage to the first and second end plates 43 and 44 (the third end plate 47) and a reduction of the manufacturing cost of the first and second end plates 43 and 44 (the third end plate 47) are both achieved.

Further, according to the aforementioned first and second embodiments, the second and fourth composition sheet members 43b and 44b (the sixth composition sheet member 47b) facing the core body 41 are formed by either one of aluminum and aluminum alloy.

Accordingly, the flux leakage to the first and second end plates 43 and 44 (the third end plate 47) is reduced and the performance of the electric motor 1 is enhanced. The first to fourth composition sheet members 43a, 43b, 44a, and 44b (the fifth and sixth composition sheet members 47a and 47b) formed by the aluminum or the aluminum alloy are inhibited from being magnetized because of the distortion upon the press-molding. Thus, the flux leakage to the first and second end plates 43 and 44 (the third end plate 47) is further reduced.

Furthermore, according to the aforementioned second embodiment, the outer diameter of the fifth composition sheet member 47a arranged to be most away from the core body 41 is smaller than the outer diameter of the sixth composition sheet member 47b facing the core body 41.

Accordingly, the flux leakage from the core body 41 is further reduced to thereby enhance the operation efficiency of the electric motor 1. In addition, because the outer diameter of the sixth composition sheet member 47b facing the core body 41 is not reduced, the force to hold the core body 41 is inhibited from decreasing.

Furthermore, according to the aforementioned first and second embodiments, each of the first to fourth composition sheet members 43a, 43b, 44a, and 44b (the fifth and sixth composition sheet members 47a and 47b) includes the annular shape and the first to fourth bores 431a, 431b, 441a, and 441b (the fifth and sixth bores 471a and 471b) arranged at the predetermined intervals in the circumferential direction.

Furthermore, according to the aforementioned first and second embodiments, the plural composition sheet members include the first to fourth composition sheet members 43a, 43b, 44a, and 44b (the fifth and sixth composition sheet members 47a and 47b), and the diameter of the inner peripheral surface of each of the third and fourth composition sheet members 44a and 44b (the fifth and sixth composition sheet members 47a and 47b) is smaller than the diameter of the inner peripheral surface of each of the first and second composition sheet members 43a and 43b.

Furthermore, each of the third and fourth composition sheet members 44a and 44b (the fifth and sixth composition sheet members 47a and 47b) includes the third and fourth bolt holes 442a and 442b (the fifth and sixth bolt bores 472a and 472b) arranged in the circumferential direction, the third bolt holes 442a (the fifth bolt holes 472a) formed at the third composition sheet member 44a (the fifth composition sheet member 47a) overlapping the fourth bolt holes 442b (the sixth bolt holes 472b) formed at the fourth composition sheet member 44b (the sixth composition sheet member 47b) in the thickness direction, the first bores 431a formed at the first composition sheet member 43a overlapping the second bores 431b formed at the second composition sheet member 43b in the thickness direction, each of the first bores 431a formed at the first composition sheet member 43a and each of the second bores 431b formed at the second composition sheet member 43b overlapping in the thickness direction are positioned between two of the bolt holes 442a (472a) formed at the third composition sheet member 44a (the fifth composition sheet member 47a) adjacent to each other and between two of the bolt holes 442b (472b) formed at the fourth composition sheet member 44b (the sixth composition sheet member 47b) adjacent to each other in the circumferential direction.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotor for a rotary electric machine, the rotor being arranged to face a stator and being roratably attached to a housing, the rotor comprising:
a core body formed by a plurality of core sheets laminated in a direction of a rotational axis of the rotor;
first and second end plates arranged at both end surfaces of the core body in a direction where the core sheets are laminated; and
a fixing member fixing the first and second end plates to the core body to hold the core body by the first and second end plates, wherein at least one of the first and second end plates is formed by a plurality of composition members overlapping in a thickness direction of the first end plate and the second end plate.

2. The rotor according to claim 1, wherein the plurality of composition members is formed by different materials from one another.

3. The rotor according to claim 1, wherein a first portion of the plurality of composition members facing the core body is formed by either one of aluminum and aluminum alloy.

4. The rotor according to claim 1, wherein an outer diameter of a second portion of the plurality of composition members arranged to be most away from the core body is smaller than an outer diameter of the first portion of the plurality of composition members facing the core body.

5. The rotor according to claim 1, wherein each of the plurality of composition members includes an annular shape and a plurality of through-bores arranged at predetermined intervals in a circumferential direction.

6. The rotor according to claim 5, wherein the plurality of composition members includes first to fourth composition members, and a diameter of an inner peripheral surface of each of the third and fourth composition members is smaller than a diameter of an inner peripheral surface of each of the first and second composition members.

7. A rotor for a rotary electric machine, the rotor being arranged to face a stator and roratably attached to a housing, the rotor comprising:
a core body formed by a plurality of core sheets laminated in a direction of a rotational axis of the rotor;
first and second end plates arranged at both end surfaces of the core body in a direction where the core sheets are laminated; and
a fixing member fixing the first and second end plates to the core body to hold the core body by the first and second end plates, wherein one of the end plates is formed by a plurality of composition members overlapping in a thickness direction, each of the plurality of composition members including an annular shape and a plurality of through-bores arranged at predetermined intervals in a circumferential direction.

8. The rotor according to claim 7, wherein the plurality of composition members includes first to fourth composition members, and a diameter of an inner peripheral surface of each of the third and fourth composition members is smaller than a diameter of an inner peripheral surface of each of the first and second composition members.

9. The rotor according to claim 8, wherein each of the third and fourth composition members includes a plurality of through-holes arranged in a circumferential direction, the plurality of through-holes formed at the third composition member overlapping the plurality of through-holes formed at the fourth composition member in the thickness direction, the plurality of through-bores formed at the first composition member overlapping the plurality of through-bores formed at the second composition member in the thickness direction, each of the plurality of through-bores formed at the first composition member and each of the plurality of through-bores formed at the second composition member overlapping in the thickness direction are positioned between two of the through-holes formed at the third composition member adjacent to each other and between two of the through-holes formed at the fourth composition member adjacent to each other in the circumferential direction.
